(19) United States
(12) Patent Application Publication
(10) Pub. No.: US 2019/0378223 A1
(43) Pub. Date: Dec. 12, 2019

(54) Systems and Methods for Flexible Redistribution of Lodging Reservations

(71) Applicant: TravelPass Group, LLC, Lehi, UT (US)

(72) Inventors: Ryan Williams, Lehi, UT (US); Ryan McCoy, Lehi, UT (US); Nelson Daniel, Lehi, UT (US); Neil Valentine, Lehi, UT (US); Scott Jensen, Lehi, UT (US)

(21) Appl. No.: 16/425,072

(22) Filed: May 29, 2019

Related U.S. Application Data
(60) Provisional application No. 62/682,519, filed on Jun. 8, 2018.

(51) Int. Cl. G06Q 50/12; G06Q 10/02; G06Q 30/06; H04L 29/08

(52) U.S. Cl. CPC G06Q 50/12; H04L 67/10; G06Q 30/0619; G06Q 10/02

(57) ABSTRACT

Systems and methods facilitate transfer of lodging reservations on a secondary market, thereby maintaining increased inventory availability and flexibility, and avoiding sold-out or no-reservations-available conditions. Would-be travelers or lodgers are permitted to benefit from changing market conditions as they are able to consider selling/transferring previously made reservations to take advantage of price changes in their favor. At the same time, lodging providers are able to participate in profits realized from increasing lodging demand and prices, even where lodging reservations were originally made long in the past.

### CROSS-REFERENCE TO RELATED APPLICATIONS

The application claims priority to U.S. Provisional Application No. 62/682,519 filed Jun. 8, 2018.

### BACKGROUND OF THE INVENTION

### 1. Field of the Invention

The present invention relates to lodging reservation systems, and more particularly to systems and methods for redistributing lodging reservations in a fashion that may prevent a sold-out state from occurring.

### 2. Background and Related Art

In the lodging industry, there are numerous difficulties inherent in the industry's general desire to maximize profitability. Generally, it is advantageous to maximize occupancy, and the industry takes measures to ensure maximum occupancy whenever possible. The lodging industry seeks to maximize occupancy in a variety of ways, including through advertising and discounts/specials, and by distributing its lodging inventory through a variety of different sources, including through its own website as well as by distributing inventory to wholesalers, third-party online travel agencies (“OTAs”) and other sources of lodging reservations. Another thing the lodging industry does to maximize occupancy is to overbook lodging based on the expectation that a certain percentage of reservations will be canceled at or near the last minute and/or will be no-shows. Overbooking carries a risk of an event where more guests with reservations show up then there are available rooms, and the lodging provider is forced to “walk” one or more would-be guests, which entails providing some form of compensation and/or seeking to provide accommodations at an alternate (usually nearby) lodging location.

The lodging industry also takes into account expected demand as it seeks to maximize occupancy and profits. In certain areas, demand is higher on weekends, and in other areas, demand is higher during the work week. Special events such as holidays and conventions can also affect demand. When demand is higher, the lodging industry typically prices its accommodations accordingly so as to maximize profits while still achieving full occupancy or something very close to it without being forced to walk many if any guests.

While lodging providers typically wish to maximize occupancy and profits, they are also faced with certain additional concerns. While maximum occupancy is generally desirable, it is also generally desirable to not reach a sold-out (or “no-vacancy”) state while there are still potential guests who wish to book accommodations at the lodging providers. This concern is especially important with respect to lodging providers' most loyal customers; if loyal customers are unable to book accommodations, the lodging provider risks losing these important and profitable customers. To this end, lodging providers may either hold back a certain number of rooms to be able to satisfy last-minute needs, or may seek to take other actions so as to ensure some room availability at almost all times. Based on long experience and/or current booking trends and projections, lodging providers may adjust their rates either daily or on some other interval so as to achieve a desired booking level at any particular time that accounts for the desire to maximize occupancy and profits, while still maintaining a desired level of room availability to accommodate later reservations.

Despite the lodging industry's efforts to maximize occupancy and profits, numerous difficulties still remain. For example, any number of events may unexpectedly take certain rooms out of service even after the rooms were booked. Disasters can occur, and a fire or flood may make any number of rooms uninhabitable. When such an event happens with sufficient lead time, the lodging provider may be able to remove inventory from distribution so that bookings for those rooms never happen. If, however, insufficient lead time remains, the lodging provider may be forced to contact reserved guests to seek voluntary cancellation of reservations or may be forced to walk customers on arrival.

On occasion, events outside of the lodging providers' control can modify or greatly modify demand in even unexpected ways. For example, while many event planners seek to schedule events with sufficient lead time to allow lodging providers to plan accordingly to provide sufficient accommodations and manage demand through appropriate pricing, some events simply cannot be planned for completely. By way of example, a local sports team might just make the playoffs at the last minute, thereby causing scheduling of one or more home games in the playoffs with as little as a few days' lead time. Interest in the playoff games can cause a significant spike in interest in lodging accommodations that lodging providers may be ill equipped to handle due to prior efforts to maximize occupancy before the sudden spike in interest.

As another example, weather-related events can significantly increase or decrease demand for lodging in unexpected ways. Some locations become temporary travel destinations due to occurrences that may be subject to the vagaries of weather. Examples include Washington, D.C., during the time of bloom of the cherry blossoms, and the northeastern United States during the peak of fall colors. Events such as these can occur over a range of dates depending on local weather conditions, and it can be impossible to accurately predict the exact dates of maximum interest until immediately before the event.

Certain events may conversely lead to sudden decreases in demand for lodging accommodations. Such events may include weather-related events, sports events (such as small-market teams advancing in sports playoff events), or any other events negatively affecting demand. It is commonplace in the lodging industry to make reservations and to only require payment at the time of the stay (“post-pay”), with free cancellation up to a short period of time (a day or two or a few days) prior to the reserved stay. Sudden decreases in demand can lead to cancellation of previously booked reservations, leading to significant under-occupancy and lost revenues for the lodging provider. At times, short lead times for such events makes it difficult to impossible to achieve maximum occupancy at any profitable price, despite lodging providers' best efforts.

Thus, despite the lodging industry's best efforts, it is impossible to perfectly predict and price lodging accommodations to maximize occupancy and to maximize revenues associated with such occupancy. As a result, lodging providers may at times experience low-occupancy conditions or may conversely experience sold-out (no-vacancy) conditions where even loyal customers are unable to make a reservation.

At time, lodging trends have pushed toward decreasing flexibility for consumers to cancel their reservations, such as by requiring a longer lead time for a full-refund or no-fee cancellation. Obviously, consumers may be discouraged by such changes and have sought options to avoid paying costly fees to lodging providers for unused services. Accordingly, secondary markets have arisen to permit even last-minute resale of lodging reservations. Examples of secondary market providers are Roomer Travel and Cancelon. These providers allow transfer of accommodation reservations between users even after a cancellation deadline has passed. While the market providers seek to work with lodging providers to ensure that the name on the reservation is appropriately changed, the new traveler runs some risk that the lodging provider will not have record of his or her reservation.

Thus, for reasons such as these, there are ongoing difficulties in the lodging reservation industry that prevent maximum occupancy and profitability for lodging providers or that may cause consumers to encounter difficulties in the reservation process, including inability to get refunds and/or encountering a sold-out state where they cannot get a reservation at any price.

### BRIEF SUMMARY OF THE INVENTION

Implementation of the invention provides systems and methods that facilitate transfer of lodging reservations on a secondary market, thereby maintaining increased inventory availability and flexibility, and avoiding sold-out or no-reservations-available conditions. Implementation of the invention also allows would-be travelers or lodgers to benefit from changing market conditions as they are able to consider selling/transferring previously made reservations to take advantage of price changes in their favor. At the same time, implementation of the invention allows lodging providers to participate in profits realized from increasing lodging demand and prices, even where lodging reservations were originally made long in the past.

Systems and methods in accordance with implementations of the invention may include or be performed by a variety of computing devices, including one or more servers coupled to one or more communications networks such as the Internet and cellular networks. As servers may take a variety of forms and may incorporate multiple servers and other computing devices operating as a single logical server, references herein to a single server embrace any server architecture, including multiple co-located or distributed servers operating in unison to provide functionality discussed herein. Similarly, as a variety of communications networks may generally be used to communicate between computing devices, as necessary (e.g., a communication to a smart phone may be equally transmitted over a cellular network as over an Internet and WiFi network), references herein to a communications network embrace the use of a single communications network, multiple communications networks, and hybrid communications networks in which a communication passes over a portion of one network and then is passed to another network for delivery.

According to implementations of the invention, a method performed by a lodging reservation redistribution server including at least one processor includes steps of receiving, from a lodger computing device operated by an original lodger and over a communications network, a request to place a reservation at a lodging facility and communicating over the communications network with a lodging provider computer to place the reservation at the lodging facility. The method further includes a step of sending a lodging reservation confirmation communication to the lodger computing device over the communications network with information about the reservation and an offer to participate in a reservation reseller program such as a locked-in sell price reseller program and a make-offer reseller program. The method includes receiving an acceptance communication from the lodger computing device over the network, the acceptance communication indicating acceptance of the offer to participate in the reservation reseller program. The method further includes steps of creating, by the processor, a listing available for distribution over the network to a plurality of computing devices, the listing offering the reservation for resale according to terms of the reservation reseller program accepted by the original lodger and storing the created listing on a storage medium accessible to the lodging reservation redistribution server. The method also includes steps of receiving a request to access one or more listings for reservations from a new lodger computing device and causing the processor to access the listing from the storage medium and to cause the lodging reservation redistribution server to transmit the listing over the network to the new lodger computing device.

The method may also include an additional step of reselling the reservation from the original lodger to a new lodger at a new price greater than an original price at which the original reservation was placed. Following resale of the reservation, the method may include distributing a first portion of a difference between the new price and the original price to a lodging provider operating a lodging facility booked by the reservation and distributing a second portion of the difference between the new price and the original price to the original lodger. The method may also include distributing a third portion of the difference between the new price and the original price to a lodging reservation redistributor operating the lodging redistribution server. Funds for resale of the reservation may be distributed at a time of resale of the reservation. Alternatively, funds for resale of the reservation may be distributed at a time when the new lodger pays to stay at the lodging facility pursuant to the reservation.

The method may include receiving identifying and payment information about the new lodger and communicating the identifying and payment information to the lodging provider to replace similar information about the original lodger.

Reselling the reservation may include steps of receiving, pursuant to the make-offer reseller program, an offer for the reservation from the new lodger, the offer exceeding the original price of the reservation, preparing and transmitting an offer-made communication of the offer to the original lodger, and receiving an offer-accepted communication from the original lodger. The new lodger may be notified that the offer has been accepted, and payment information and other identifying information may be received from the new lodger. A lodging provider computing system may be notified that the reservation has been resold to the new lodger and providing the payment information and other identifying information of the new lodger to the lodging provider computing system.

Reselling the reservation may include steps of receiving, pursuant to the locked-in sell price reseller program, an offer for the reservation from the new buyer, the offer matching a sell price set by the original lodger and listed in the listing, the sell price exceeding the original price, receiving payment information and other identifying information from the new lodger, preparing and transmitting a reservation-sold communication to the original lodger, and notifying a lodging provider computing system that the reservation has been resold to the new lodger and providing the payment information and the other identifying information of the new lodger to the lodging provider computing system. The locked-in seller program may have a time-based escalating sell price for the reservation as a start date of the reservation nears, whereby the sell price for the reservation increases with temporal proximity to the start date of the reservation. The method may include receiving a communication from the original lodger at the time of acceptance of the locked-in sell price reseller program providing an indication of the sell price at which the original lodger is willing to sell the reservation.

The listing may include an end date whereupon an offer to repurchase the reservation from the original lodger will no longer be entertained. The method may include additional steps of receiving, from the new lodger computing device, a search for lodging accommodations with search parameters that correspond to the created listing and delivering the listing over the network to the new lodger computing device as an option matching the search for lodging accommodations.

According to further implementations of the invention, a method performed by a lodging reservation redistribution server including at least one processor includes steps of receiving, from a lodging provider computing device and over a communications network, a notification indicating that an original lodger has placed a reservation at a lodging facility, and sending, over the communications network, an offer to a lodger computing device inviting the original lodger to participate in a reservation reseller program such as a locked-in sell price reseller program and a make-offer reseller program. The method further includes steps of receiving an acceptance communication from the lodger computing device over the network, the acceptance communication indicating acceptance of the offer to participate in the reservation reseller program, creating, by the processor, a listing available for distribution over the network to a plurality of computing devices, the listing offering the reservation for resale according to terms of the reservation reseller program accepted by the original lodger, and storing the created listing on a storage medium accessible to the lodging reservation redistribution server. The method also includes steps of receiving a request to access one or more listings for reservations from a new lodger computing device and causing the processor to access the listing from the storage medium and to cause the lodging reservation redistribution server to transmit the listing over the network to the new lodger computing device.

The method may also include steps of reselling the reservation from the original lodger to a new lodger at a new price greater than an original price at which the original reservation was placed, distributing a first portion of a difference between the new price and the original price to a lodging provider operating a lodging facility booked by the reservation, distributing a second portion of the difference between the new price and the original price to the original lodger, and distributing a third portion of the difference between the new price and the original price to a lodging reservation redistributor operating the lodging redistribution server. Funds for resale of the reservation may be distributed at a time of resale of the reservation. Alternatively, funds for resale of the reservation may be distributed at a time when the new lodger pays to stay at the lodging facility pursuant to the reservation.

The method may also include steps of receiving identifying and payment information about the new lodger and communicating the identifying and payment information to the lodging provider to replace similar information about the original lodger.

Reselling the reservation may include steps of receiving, pursuant to the make-offer reseller program, an offer for the reservation from the new lodger, the offer exceeding the original price of the reservation, preparing and transmitting an offer-made communication of the offer to the original lodger, and receiving an offer-accepted communication from the original lodger. Reselling the reservation may also include steps of notifying the new lodger that the offer has been accepted, receiving payment information and other identifying information from the new lodger, and notifying a lodging provider computing system that the reservation has been resold to the new lodger and providing the payment information and other identifying information of the new lodger to the lodging provider computing system.

Reselling the reservation may include steps of receiving, pursuant to the locked-in sell price reseller program, an offer for the reservation from the new buyer, the offer matching a sell price set by the original lodger and listed in the listing, the sell price exceeding the original price, receiving payment information and other identifying information from the new lodger, preparing and transmitting a reservation-sold communication to the original lodger, and notifying a lodging provider computing system that the reservation has been resold to the new lodger and providing the payment information and the other identifying information of the new lodger to the lodging provider computing system. The locked-in seller program may include a time-based escalating sell price for the reservation as a start date of the reservation nears, whereby the sell price for the reservation increases with temporal proximity to the start date of the reservation. The method may include receiving a communication from the original lodger at the time of acceptance of the locked-in sell price reseller program, the communication providing an indication of the sell price at which the original lodger is willing to sell the reservation.

The method may further include steps of receiving, from the new lodger computing device, a search for lodging accommodations with search parameters that correspond to the created listing and delivering the listing over the network to the new lodger computing device as an option matching the search for lodging accommodations.

According to additional implementations of the invention, a method performed by a lodging reservation redistribution server including at least one processor includes steps of receiving, from a lodger computing device operated by an original lodger and over a communications network, a request to place a reservation at a lodging facility and generating and sending a lodging reservation confirmation communication to the lodger computing device over the communications network with information about the reservation and an offer to participate in a reservation reseller program such as a locked-in sell price reseller program and a make-offer reseller program. The method also includes steps of receiving an acceptance communication from the lodger computing device over the network, the acceptance communication indicating acceptance of the offer to participate in the reservation reseller program, creating, by the processor, a listing available for distribution over the network to a plurality of computing devices, the listing offering the reservation for resale according to terms of the reservation reseller program accepted by the original lodger, and storing the created listing on a storage medium accessible to the lodging reservation redistribution server. The method further includes steps of receiving a request to access one or more listings for reservations from a new lodger computing device and causing the processor to access the listing from the storage medium and to cause the lodging reservation redistribution server to transmit the listing over the network to the new lodger computing device.

The method may also include steps of reselling the reservation from the original lodger to a new lodger at a new price greater than an original price at which the original reservation was placed, distributing a first portion of a difference between the new price and the original price to a lodging provider operating a lodging facility booked by the reservation, and distributing a second portion of the difference between the new price and the original price to the original lodger. Funds for resale of the reservation may be distributed at a time of resale of the reservation. Alternatively, funds for resale of the reservation may be distributed at a time when the new lodger pays to stay at the lodging facility pursuant to the reservation.

Reselling the reservation may include steps of receiving, pursuant to the make-offer reseller program, an offer for the reservation from the new lodger, the offer exceeding the original price of the reservation, preparing and transmitting an offer-made communication of the offer to the original lodger, and receiving an offer-accepted communication from the original lodger. Reselling the reservation may also include steps of notifying the new lodger that the offer has been accepted and receiving payment information and other identifying information from the new lodger.

Reselling the reservation may include steps of receiving, pursuant to the locked-in sell price reseller program, an offer for the reservation from the new buyer, the offer matching a sell price set by the original lodger and listed in the listing, the sell price exceeding the original price, receiving payment information and other identifying information from the new lodger, and preparing and transmitting a reservation-sold communication to the original lodger. The locked-in seller program may have a time-based escalating sell price for the reservation as a start date of the reservation nears, whereby the sell price for the reservation increases with temporal proximity to the start date of the reservation. The method may include a step of receiving a communication from the original lodger at the time of acceptance of the locked-in sell price reseller program, the communication providing an indication of the sell price at which the original lodger is willing to sell the reservation.

According to other implementations of the invention, a method to facilitate a secondary lodging reservation market and reduce a likelihood of a sold-out lodging occurrence performed by a lodging reservation redistribution server including at least one processor includes a step of at a time of making a lodging reservation, generating and sending an offer to a lodger computing device controlled by an original lodger making the lodging reservation, the offer inviting the original lodger to participate in a reservation reseller program selected from the group of a locked-in sell price reseller program and a make-offer reseller program. The method also includes steps of receiving an acceptance communication from the lodger computing device, the acceptance communication indicating acceptance of the offer to participate in the reservation reseller program, creating an electronic listing available for distribution over a network to a plurality of computing devices, the listing offering the reservation for resale according to terms of the reservation reseller program accepted and set by the original lodger, and storing the created listing on a storage medium accessible to a network-connected lodging reservation redistribution server. The method also includes steps of receiving a request to access one or more listings for reservations from a new lodger computing device and causing the processor to access the listing from the storage medium and to cause the lodging reservation redistribution server to transmit the listing over the network to the new lodger computing device.

The method may further include steps of reselling the reservation from the original lodger to a new lodger at a new price greater than an original price at which the original reservation was placed, distributing a first portion of a difference between the new price and the original price to a lodging provider operating a lodging facility booked by the reservation, and distributing a second portion of the difference between the new price and the original price to the original lodger. Funds for resale of the reservation may be distributed at a time of resale of the reservation. Alternatively, funds for resale of the reservation may be distributed at a time when the new lodger pays to stay at the lodging facility pursuant to the reservation.

Reselling the reservation may include steps of receiving, pursuant to the make-offer reseller program, an offer for the reservation from the new lodger, the offer exceeding the original price of the reservation, preparing and transmitting an offer-made communication of the offer to the original lodger, and receiving an offer-accepted communication from the original lodger. Reselling the reservation may also include steps of notifying the new lodger that the offer has been accepted and receiving payment information and other identifying information from the new lodger.

Reselling the reservation may include steps of receiving, pursuant to the locked-in sell price reseller program, an offer for the reservation from the new buyer, the offer matching a sell price set by the original lodger and listed in the listing, the sell price exceeding the original price, receiving payment information and other identifying information from the new lodger, and preparing and transmitting a reservation-sold communication to the original lodger. The locked-in seller program may have a time-based escalating sell price for the reservation as a start date of the reservation nears, whereby the sell price for the reservation increases with temporal proximity to the start date of the reservation. The method may include a step of receiving a communication from the original lodger at the time of acceptance of the locked-in sell price reseller program, the communication providing an indication of the sell price at which the original lodger is willing to sell the reservation. The listing may have an end date whereupon an offer to repurchase the reservation from the original lodger will no longer be entertained. Accordingly, the would-be traveler can be sure of his or her plans after the end date.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system for use with embodiments of the invention; and

FIG. 2 shows a representative networked computer system for use with embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods that facilitate transfer of lodging reservations on a secondary market, thereby maintaining increased inventory availability and flexibility, and avoiding sold-out or no-reservations-available conditions. Embodiments of the invention also allows would-be travelers or lodgers to benefit from changing market conditions as they are able to consider selling/transferring previously made reservations to take advantage of price changes in their favor. At the same time, embodiments of the invention allows lodging providers to participate in profits realized from increasing lodging demand and prices, even where lodging reservations were originally made long in the past.

Systems and methods in accordance with embodiments of the invention may include or be performed by a variety of computing devices, including one or more servers coupled to one or more communications networks such as the Internet and cellular networks. As servers may take a variety of forms and may incorporate multiple servers and other computing devices operating as a single logical server, references herein to a single server embrace any server architecture, including multiple co-located or distributed servers operating in unison to provide functionality discussed herein. Similarly, as a variety of communications networks may generally be used to communicate between computing devices, as necessary (e.g., a communication to a smart phone may be equally transmitted over a cellular network as over an Internet and WiFi network), references herein to a communications network embrace the use of a single communications network, multiple communications networks, and hybrid communications networks in which a communication passes over a portion of one network and then is passed to another network for delivery.

According to embodiments of the invention, a method performed by a lodging reservation redistribution server including at least one processor includes steps of receiving, from a lodger computing device operated by an original lodger and over a communications network, a request to place a reservation at a lodging facility and communicating over the communications network with a lodging provider computer to place the reservation at the lodging facility. The method further includes a step of sending a lodging reservation confirmation communication to the lodger computing device over the communications network with information about the reservation and an offer to participate in a reservation reseller program such as a locked-in sell price reseller program and a make-offer reseller program. The method includes receiving an acceptance communication from the lodger computing device over the network, the acceptance communication indicating acceptance of the offer to participate in the reservation reseller program. The method further includes steps of creating, by the processor, a listing available for distribution over the network to a plurality of computing devices, the listing offering the reservation for resale according to terms of the reservation reseller program accepted by the original lodger and storing the created listing on a storage medium accessible to the lodging reservation redistribution server. The method also includes steps of receiving a request to access one or more listings for reservations from a new lodger computing device and causing the processor to access the listing from the storage medium and to cause the lodging reservation redistribution server to transmit the listing over the network to the new lodger computing device.

The method may also include an additional step of reselling the reservation from the original lodger to a new lodger at a new price greater than an original price at which the original reservation was placed. Following resale of the reservation, the method may include distributing a first portion of a difference between the new price and the original price to a lodging provider operating a lodging facility booked by the reservation and distributing a second portion of the difference between the new price and the original price to the original lodger. The method may also include distributing a third portion of the difference between the new price and the original price to a lodging reservation redistributor operating the lodging redistribution server. Funds for resale of the reservation may be distributed at a time of resale of the reservation. Alternatively, funds for resale of the reservation may be distributed at a time when the new lodger pays to stay at the lodging facility pursuant to the reservation.

The method may include receiving identifying and payment information about the new lodger and communicating the identifying and payment information to the lodging provider to replace similar information about the original lodger.

Reselling the reservation may include steps of receiving, pursuant to the make-offer reseller program, an offer for the reservation from the new lodger, the offer exceeding the original price of the reservation, preparing and transmitting an offer-made communication of the offer to the original lodger, and receiving an offer-accepted communication from the original lodger. The new lodger may be notified that the offer has been accepted, and payment information and other identifying information may be received from the new lodger. A lodging provider computing system may be notified that the reservation has been resold to the new lodger and providing the payment information and other identifying information of the new lodger to the lodging provider computing system.

Reselling the reservation may include steps of receiving, pursuant to the locked-in sell price reseller program, an offer for the reservation from the new buyer, the offer matching a sell price set by the original lodger and listed in the listing, the sell price exceeding the original price, receiving payment information and other identifying information from the new lodger, preparing and transmitting a reservation-sold communication to the original lodger, and notifying a lodging provider computing system that the reservation has been resold to the new lodger and providing the payment information and the other identifying information of the new lodger to the lodging provider computing system. The locked-in seller program may have a time-based escalating sell price for the reservation as a start date of the reservation nears, whereby the sell price for the reservation increases with temporal proximity to the start date of the reservation. The method may include receiving a communication from the original lodger at the time of acceptance of the locked-in sell price reseller program providing an indication of the sell price at which the original lodger is willing to sell the reservation.

The listing may include an end date whereupon an offer to repurchase the reservation from the original lodger will no longer be entertained. The method may include additional steps of receiving, from the new lodger computing device, a search for lodging accommodations with search parameters that correspond to the created listing and delivering the listing over the network to the new lodger computing device as an option matching the search for lodging accommodations.

According to further embodiments of the invention, a method performed by a lodging reservation redistribution server including at least one processor includes steps of receiving, from a lodging provider computing device and over a communications network, a notification indicating that an original lodger has placed a reservation at a lodging facility, and sending, over the communications network, an offer to a lodger computing device inviting the original lodger to participate in a reservation reseller program such as a locked-in sell price reseller program and a make-offer reseller program. The method further includes steps of receiving an acceptance communication from the lodger computing device over the network, the acceptance communication indicating acceptance of the offer to participate in the reservation reseller program, creating, by the processor, a listing available for distribution over the network to a plurality of computing devices, the listing offering the reservation for resale according to terms of the reservation reseller program accepted by the original lodger, and storing the created listing on a storage medium accessible to the lodging reservation redistribution server. The method also includes steps of receiving a request to access one or more listings for reservations from a new lodger computing device and causing the processor to access the listing from the storage medium and to cause the lodging reservation redistribution server to transmit the listing over the network to the new lodger computing device.

The method may also include steps of reselling the reservation from the original lodger to a new lodger at a new price greater than an original price at which the original reservation was placed, distributing a first portion of a difference between the new price and the original price to a lodging provider operating a lodging facility booked by the reservation, distributing a second portion of the difference between the new price and the original price to the original lodger, and distributing a third portion of the difference between the new price and the original price to a lodging reservation redistributor operating the lodging redistribution server. Funds for resale of the reservation may be distributed at a time of resale of the reservation. Alternatively, funds for resale of the reservation may be distributed at a time when the new lodger pays to stay at the lodging facility pursuant to the reservation.

The method may also include steps of receiving identifying and payment information about the new lodger and communicating the identifying and payment information to the lodging provider to replace similar information about the original lodger.

Reselling the reservation may include steps of receiving, pursuant to the make-offer reseller program, an offer for the reservation from the new lodger, the offer exceeding the original price of the reservation, preparing and transmitting an offer-made communication of the offer to the original lodger, and receiving an offer-accepted communication from the original lodger. Reselling the reservation may also include steps of notifying the new lodger that the offer has been accepted, receiving payment information and other identifying information from the new lodger, and notifying a lodging provider computing system that the reservation has been resold to the new lodger and providing the payment information and other identifying information of the new lodger to the lodging provider computing system.

Reselling the reservation may include steps of receiving, pursuant to the locked-in sell price reseller program, an offer for the reservation from the new buyer, the offer matching a sell price set by the original lodger and listed in the listing, the sell price exceeding the original price, receiving payment information and other identifying information from the new lodger, preparing and transmitting a reservation-sold communication to the original lodger, and notifying a lodging provider computing system that the reservation has been resold to the new lodger and providing the payment information and the other identifying information of the new lodger to the lodging provider computing system. The locked-in seller program may include a time-based escalating sell price for the reservation as a start date of the reservation nears, whereby the sell price for the reservation increases with temporal proximity to the start date of the reservation. The method may include receiving a communication from the original lodger at the time of acceptance of the locked-in sell price reseller program, the communication providing an indication of the sell price at which the original lodger is willing to sell the reservation.

The method may further include steps of receiving, from the new lodger computing device, a search for lodging accommodations with search parameters that correspond to the created listing and delivering the listing over the network to the new lodger computing device as an option matching the search for lodging accommodations.

According to additional embodiments of the invention, a method performed by a lodging reservation redistribution server including at least one processor includes steps of receiving, from a lodger computing device operated by an original lodger and over a communications network, a request to place a reservation at a lodging facility and generating and sending a lodging reservation confirmation communication to the lodger computing device over the communications network with information about the reservation and an offer to participate in a reservation reseller program such as a locked-in sell price reseller program and a make-offer reseller program. The method also includes steps of receiving an acceptance communication from the lodger computing device over the network, the acceptance communication indicating acceptance of the offer to participate in the reservation reseller program, creating, by the processor, a listing available for distribution over the network to a plurality of computing devices, the listing offering the reservation for resale according to terms of the reservation reseller program accepted by the original lodger, and storing the created listing on a storage medium accessible to the lodging reservation redistribution server. The method further includes steps of receiving a request to access one or more listings for reservations from a new lodger computing device and causing the processor to access the listing from the storage medium and to cause the lodging reservation redistribution server to transmit the listing over the network to the new lodger computing device.

The method may also include steps of reselling the reservation from the original lodger to a new lodger at a new price greater than an original price at which the original reservation was placed, distributing a first portion of a difference between the new price and the original price to a lodging provider operating a lodging facility booked by the reservation, and distributing a second portion of the difference between the new price and the original price to the original lodger. Funds for resale of the reservation may be distributed at a time of resale of the reservation. Alternatively, funds for resale of the reservation may be distributed at a time when the new lodger pays to stay at the lodging facility pursuant to the reservation.

Reselling the reservation may include steps of receiving, pursuant to the make-offer reseller program, an offer for the reservation from the new lodger, the offer exceeding the original price of the reservation, preparing and transmitting an offer-made communication of the offer to the original lodger, and receiving an offer-accepted communication from the original lodger. Reselling the reservation may also include steps of notifying the new lodger that the offer has been accepted and receiving payment information and other identifying information from the new lodger.

Reselling the reservation may include steps of receiving, pursuant to the locked-in sell price reseller program, an offer for the reservation from the new buyer, the offer matching a sell price set by the original lodger and listed in the listing, the sell price exceeding the original price, receiving payment information and other identifying information from the new lodger, and preparing and transmitting a reservation-sold communication to the original lodger. The locked-in seller program may have a time-based escalating sell price for the reservation as a start date of the reservation nears, whereby the sell price for the reservation increases with temporal proximity to the start date of the reservation. The method may include a step of receiving a communication from the original lodger at the time of acceptance of the locked-in sell price reseller program, the communication providing an indication of the sell price at which the original lodger is willing to sell the reservation.

According to other embodiments of the invention, a method to facilitate a secondary lodging reservation market and reduce a likelihood of a sold-out lodging occurrence performed by a lodging reservation redistribution server including at least one processor includes a step of at a time of making a lodging reservation, generating and sending an offer to a lodger computing device controlled by an original lodger making the lodging reservation, the offer inviting the original lodger to participate in a reservation reseller program selected from the group of a locked-in sell price reseller program and a make-offer reseller program. The method also includes steps of receiving an acceptance communication from the lodger computing device, the acceptance communication indicating acceptance of the offer to participate in the reservation reseller program, creating an electronic listing available for distribution over a network to a plurality of computing devices, the listing offering the reservation for resale according to terms of the reservation reseller program accepted and set by the original lodger, and storing the created listing on a storage medium accessible to a network-connected lodging reservation redistribution server. The method also includes steps of receiving a request to access one or more listings for reservations from a new lodger computing device and causing the processor to access the listing from the storage medium and to cause the lodging reservation redistribution server to transmit the listing over the network to the new lodger computing device.

The method may further include steps of reselling the reservation from the original lodger to a new lodger at a new price greater than an original price at which the original reservation was placed, distributing a first portion of a difference between the new price and the original price to a lodging provider operating a lodging facility booked by the reservation, and distributing a second portion of the difference between the new price and the original price to the original lodger. Funds for resale of the reservation may be distributed at a time of resale of the reservation. Alternatively, funds for resale of the reservation may be distributed at a time when the new lodger pays to stay at the lodging facility pursuant to the reservation.

Reselling the reservation may include steps of receiving, pursuant to the make-offer reseller program, an offer for the reservation from the new lodger, the offer exceeding the original price of the reservation, preparing and transmitting an offer-made communication of the offer to the original lodger, and receiving an offer-accepted communication from the original lodger. Reselling the reservation may also include steps of notifying the new lodger that the offer has been accepted and receiving payment information and other identifying information from the new lodger.

Reselling the reservation may include steps of receiving, pursuant to the locked-in sell price reseller program, an offer for the reservation from the new buyer, the offer matching a sell price set by the original lodger and listed in the listing, the sell price exceeding the original price, receiving payment information and other identifying information from the new lodger, and preparing and transmitting a reservation-sold communication to the original lodger. The locked-in seller program may have a time-based escalating sell price for the reservation as a start date of the reservation nears, whereby the sell price for the reservation increases with temporal proximity to the start date of the reservation. The method may include a step of receiving a communication from the original lodger at the time of acceptance of the locked-in sell price reseller program, the communication providing an indication of the sell price at which the original lodger is willing to sell the reservation. The listing may have an end date whereupon an offer to repurchase the reservation from the original lodger will no longer be entertained. Accordingly, the would-be traveler can be sure of his or her plans after the end date.

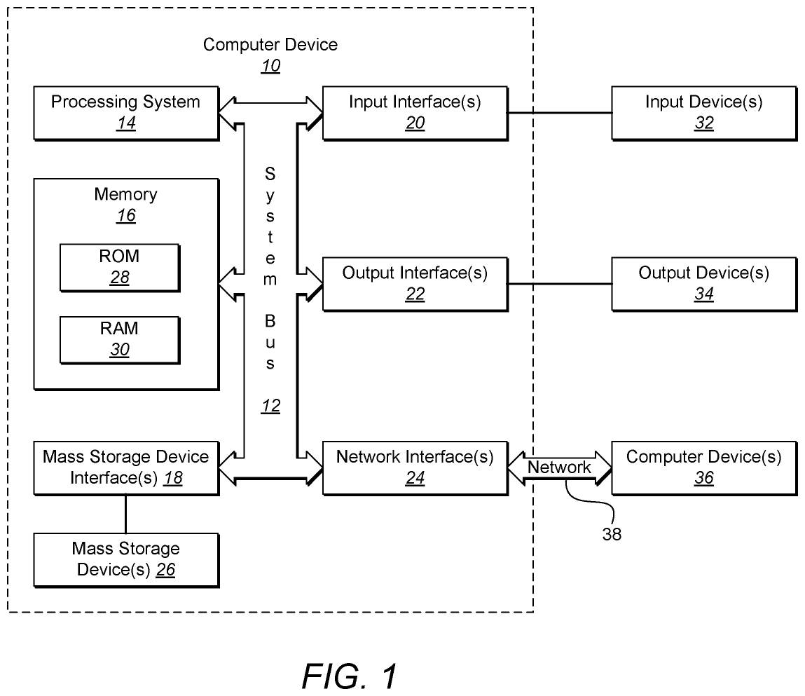

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand-alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a server, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, optical disk drives, and flash memory drives. A mass storage device 26 may read from and/or write to a magnetic hard disk, a removable magnetic disk, a magnetic cassette, an optical disk, flash memory, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices, including devices on the cloud.

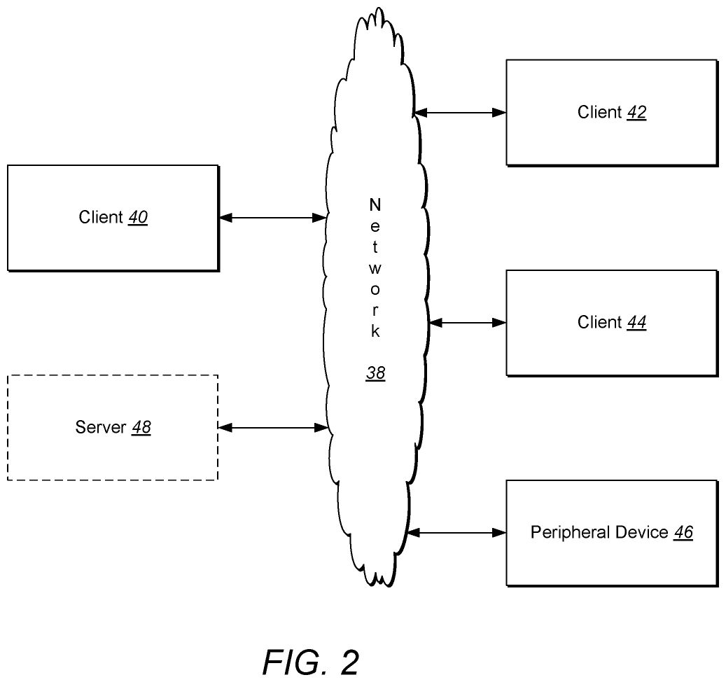

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38. Alternative embodiments include more or fewer clients, more than one peripheral device, no peripheral devices, no server 48, and/or more than one server 48 connected to network 38. Additionally, it should be understood that the one or more servers 48 may each be implemented as multiple computing devices operating together as one functional server. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

Embodiments of the invention utilize computer resources such as those shown in FIGS. 1 and 2 in a lodging reservation environment. For example, it is common for would-be travelers to use their individual computing devices, such as desktop computers, laptop computers, tablets, smart phones, and the like, to access a lodging reservation site or an online travel agency (OTA) site through a network such as the Internet, to conduct research regarding lodging reservations and other travel plans, and to then place and/or pay for one or more lodging reservations through the accessed site. Alternatively or additionally, one or more off-line resources may be utilized to assist in the research and reservation process, such as when a consumer initially conducts research online and then completes a reservation after placing a telephone call to a call center for customer assistance. In some embodiments, steps relating to the original placement of a lodging reservation may involve customer interaction with multiple entities, either serially or cooperatively. The same may be true for steps relating to reselling reservations. The lodging reservation or lodging redistribution site may be operated by the lodging provider where the lodging reservation will be fulfilled, by an online travel agency, by a dedicated lodging reservation middleman or by any other lodging reservation source.

Embodiments of the invention introduce a lodging reservation redistributor into the lodging reservation and fulfilment process. The lodging reservation redistributor may be the same entity that is the original lodging reservation vendor, and may operate at the same site operated by the original lodging reservation vendor. Alternatively, the lodging reservation redistributor may be the same entity that is the original lodging reservation vendor, but may operate at an entirely different site or at a site that is only loosely affiliated with the original vendor site. As still another alternative, the lodging reservation redistributor may be a separate entity from the original lodging reservation vendor, though the lodging reservation redistributor may still operate through the original lodging reservation vendor site or through an affiliated site. Finally, the lodging reservation redistributor may be a separate entity operating at an entirely different site.

Regardless of the relationship between the lodging reservation redistributor and the original lodging reservation vendor, the lodging reservation redistributor may be introduced into the lodging reservation purchasing process at the time of lodging reservation purchase, or at a time shortly thereafter. The lodging reservation redistributor may serve several purposes, including providing for the secure transfer of previously reserved lodging reservations from willing sellers to willing buyers. While the lodging reservation redistributor may also allow for the resale of lodging reservations by original lodging reservation purchasers at any price (e.g., at a price lower than the original price), one of the unique services of the lodging reservation redistributor is facilitating the sale of lodging reservations at a higher-than-original-reservation-value price, while allowing the original lodging reservation vendor to participate in and benefit from the increased sale price. Doing so buffers the original lodging reservation vendor from totally missing out on revenues due to increased demand for lodging reservations that the original lodging reservation vendor would typically not benefit from.

The lodging reservation vendor is motivated to participate with the lodging reservation redistributor (when the vendor and redistributor are separate entities) because of the promise of potential increased revenue received when lodging reservations are sold at a higher-than-original price. Accordingly, at the point of reservation or at some point after the point of reservation, a communication is generated and either displayed or sent to the original lodging reservation maker informing the original lodging reservation maker of a lodging reservation reseller program offered by the lodging reservation redistributor, and providing the original lodging reservation maker with an opportunity to opt in to participate in the lodging reservation reseller program. The lodging reservation reseller program is entirely optional, and if the original lodging reservation maker chooses not to participate, the lodging reservation process proceeds as normal. In some embodiments, the original lodging reservation maker may originally elect not to participate in the lodging reservation reseller program, but may elect to participate in the program at a later date, such as using a link provided with an electronic copy of his or her lodging reservation(s).

If the original lodging reservation maker reviews the information presented regarding the lodging reservation reseller program and determines to opt in to the lodging reservation reseller program, the original lodging reservation maker can interact further with the lodging reservation redistributor (e.g. through communications provided by and to a lodging reservation redistribution server operated by the lodging reservation redistributor) to select the terms under which the original lodging reservation maker will participate in the lodging reservation reseller program.

The lodging reservation reseller program may be one of several varieties operating on different principles, and the original lodging reservation maker may be provided an opportunity to participate in the variety or varieties in which he or she wishes to participate. According to a first reseller program format, the reseller program is a locked-in sell price reseller program. In this reseller program format, the original lodging reservation maker selects a fixed price at which he or she is willing to part with the lodging reservation he or she originally made and commits to sell the lodging reservation at that price if offered. If the lodging reservation redistributor receives an offer (and, potentially—depending on the embodiment, payment) for the lodging reservation that matches the fixed price set by the original lodging reservation maker (plus any additional amount added by the lodging reservation redistributor to provide a desired level of revenue for the original lodging reservation vendor and a desired level of revenue for the lodging reservation redistributor), then the original lodging reservation maker is committed to sell the lodging reservation he or she originally made. The original lodging reservation maker is then free to make alternate arrangements for another place to stay or to simply cancel his or her travel plans or to make plans to travel to another location.

To facilitate the orderly transfer of resold/repurchased lodging reservations from the original lodging reservation maker to a new buyer, lodging reservations are generally maintained in an electronic format, and as lodging reservation holders have become accustomed to electronic lodging reservations in recent years, the lodging reservation redemption process will be essentially unchanged. The only difference is that when a lodging reservation is resold, the lodging reservation redistributor or lodging reservation redistribution server automatically contacts the original lodging reservation vendor (and/or the lodging provider such as hotel/motel, etc., as appropriate in a particular circumstance and as instructed by the original lodging reservation vendor) and causes replacement of the original lodging reservation maker's identifying information with the new buyer's identifying information. Accordingly, when the new buyer arrives at the lodging facility with the lodging reservation, his or her identifying information is already associated with the lodging reservation and check-in proceeds as if the new buyer had been the original lodging reservation maker, passing any applicable identification checks. Similarly, if the original lodging reservation maker were to attempt to use the lodging reservation he or she originally made and later resold, the attempt to do so would not be successful due to the sale of the original lodging reservation. As needed, the original lodging reservation can be cancelled upon the sale and a new lodging reservation issued to the new buyer.

The lodging reservation redistributor and/or the lodging reservation redistribution server handles the necessary processes to facilitate the advertising and sale of the lodging reservation under the locked-in sell price reseller program. When the original lodging reservation maker opts in to the reseller program, the original lodging reservation maker is provided with an opportunity to select the price at which he or she agrees to sell the lodging reservation made or being made (in the case where the opt-in process occurs simultaneously with placement of the reservation). Next, a listing of the lodging reservation is generated (e.g., by a processor of the lodging reservation redistribution server), which includes information about the lodging reservation available for purchase, as well as an asking price for the lodging reservation. Notably, the asking price for the lodging reservation included in the listing may be greater than the price selected by the original lodging reservation purchaser: the lodging reservation redistribution server automatically increases the price selected by the original lodging reservation purchaser to account for additional revenue to be passed to the original lodging reservation vendor, as well as revenue to the lodging reservation redistributor for offering and hosting the lodging reservation reseller program.

As an example, suppose the original lodging reservation price is $100 per night, and the original lodging reservation maker opts in to a locked-in sell price reseller program, agreeing to sell his or her lodging reservation if an offer for $400 is received. The lodging reservation redistributor wishes to ensure that if the lodging reservation is later repurchased, the original lodging reservation maker will receive a full $400, the amount requested by the original lodging reservation maker when opting in to the lodging reservation reseller program. Accordingly, the listing for the lodging reservation may include an asking price that is modestly to significantly higher than the $400 price selected by the original lodging reservation maker, such as, for example only, $450. Then, when the new buyer wishes to buy the lodging reservation, he or she pays $450, $300 (in the event the lodging reservation was not pre-paid) or $400 (in the event the original lodging reservation was pre-paid) is distributed to the original lodging reservation maker and the original lodging reservation purchaser is notified that the lodging reservation is no longer his or hers. The remaining amount ($50 in this example) is split between the lodging reservation redistributor and the original vendor (or other designated entity such as event organizer or venue) according to terms agreed upon between the lodging reservation redistributor and the vendor. As may be appreciated, the distribution of funds may occur according to any desired or agreed-upon calculation. Additionally, where taxes are required to be collected, the system may be configured to collect an appropriate amount of tax as part of the transaction.

As an alternative, the original lodging reservation maker may be provided with terms notifying the maker of the percentages that will be retained upon repurchase of the lodging reservation so that the original lodging reservation maker clearly understands what he or she will receive upon repurchase of the lodging reservation. For example, the system may provide an interface with an entry field for the original lodging reservation maker to input his or her asking price, with additional fields that autofill accordingly to show the commission or fee and any tax that will be withheld at that price and the actual funds that will be received by the original lodging reservation maker upon repurchase of the lodging reservation by the new buyer. The converse may also be true: the user may fill in a field showing the final amount he or she wishes to receive, and the system may autofill other fields showing the commission that will be required by the system, any applicable taxes, and what the final asking price will be.

As may be appreciated, many lodging reservation systems permit reservations to be placed with payment. In such instances, where the lodging provider has already received payment for the lodging reservation, and the lodging reservation is then resold, the later reservation purchaser may be required to make payment in full at the time of purchasing the reservation. Funds may then be distributed in such situations immediately after funds are received from the new reservation purchaser.

In other cases, lodging reservation systems often permit lodging reservations to be placed without payment at the time of purchase (post-pay), and payment is expected at the time of arrival to stay at the lodging facility or at some intermediate time before arrival. Typically, where the customer is not required to pre-pay for the reservation at the time of making the reservation, the customer is required to provide payment information (a credit card number) that can be used at the time of arriving to use the reservation, or that can alternatively be used in the event the customer does not cancel the reservation with sufficient advance notice or fails to show up to use the reservation. In such situations, the lodging facility and the lodging reservation provider (if separate) may only receive funds for the original lodging reservation at (or near, if payment becomes due shortly before the start date of the reservation) the time the reservation is used or missed and the customer is billed. When such reservations are to be resold, care may be used in managing the monetary risks to the various parties as collection and distribution of funds is required and occurs.

For example, in one embodiment, the new lodging reservation purchaser may be required to pay in full for the reservation at the time of purchasing the reservation. In such embodiments, funds may be distributed immediately thereafter to all involved parties. In other embodiments, however, the new lodging reservation purchaser may not be required to pay in full for the reservation, but may be required to pay, at the time of purchase of the reservation, the difference between the original reservation price and the total purchase price of the reservation (including any commissions to the lodging reservation redistributor, the lodging provider, and/or the original lodging reservation system). In this way, the monetary position between the new customer and the commercial parties will remain the same, and the original reservation maker will be able to be fully reimbursed for the sale of the reservation.

By way of example, if the original reservation is for $100 per night, the asking price is $200 per night, and the service fee to be charged to the purchaser is $25 per night, the total cost to the reservation purchaser will be $225 per night, and the reservation purchaser may be required to pay $125 per night at the time of purchase of the reservation. In this way, the original lodging reservation maker receives $100 per night for forgoing the reservation, paid in full, and is able to make appropriate plans accordingly. Meanwhile, the lodging redistribution provider may be paid its full service fees. Finally, the lodging facility (e.g., hotel, motel, etc.) is in the same position—it has an unpaid reservation in place for $100 per night, and has the payment details of the new lodging reservation purchaser so it can bill the lodger if the reservation is not timely canceled. In sum, the only thing that changes for the lodging provider is the name on the reservation.

In any event, the original lodging reservation maker is informed prior to opting in to the locked-in sell price reseller program that any repurchase/resale of his or her lodging reservation according to the price selected by the original lodging reservation purchaser is final and cannot be reversed. If a buyer agrees to purchase the lodging reservation at the listing price and pays, the system will automatically transfer the lodging reservation to the new buyer (cancelling old lodging reservations and reissuing new lodging reservations if necessary and contacting the original lodging provider or other involved party with information about the new buyer as necessary), transfer funds to the original lodging reservation maker, and communicate to the original lodging reservation maker that the repurchase/resale has been completed and that the lodging reservation is no longer owned by the original lodging reservation maker.

The original lodging reservation maker may be provided with an opportunity to set a last sale date whereby sale must occur or the listing will be terminated and the original lodging reservation maker will automatically cease participating in the locked-in sell price reseller program. For example, if the original lodging reservation maker wishes to be sure he or she can finalize plans to user the lodging reservation one week before the reservation start date, then he or she can set terms to end the listing and prevent sale of his or her lodging reservation on a date one week (or one week and one day) before the event. Alternatively or additionally, the original lodging reservation maker can set an escalating sale price to compensate for the inconvenience that will occur with later sale of the lodging reservation at a time more proximate to the event. Thus, for example, the original lodging reservation purchaser may be willing to sell the lodging reservation for $300 per night three weeks prior to the event, but only be willing to sell for $400 per night between three weeks and two weeks prior to the event and for $500 per night between two weeks and one week prior to the event.

According to some embodiments, the system may allow the original lodging reservation maker to opt back out of the locked-in sell price reseller program at any time prior to resale/repurchase of the lodging reservation. Some embodiments may additionally or alternatively allow the original lodging reservation maker to modify the terms upon which sale may occur. For example, the original lodging reservation maker may become aware of reasons for increased demand for the event and may log in to the system to increase his or her asking price. Alternatively, the original lodging reservation maker may have a conflict arise and may log in to the system to decrease his or her asking price. Accordingly, the original lodging reservation maker remains in full control of the locked-in sell price reseller program until such time as the lodging reservation is sold.

Another lodging reservation reseller program that may be offered by the lodging reservation redistributor is a make-offer reseller program. This program may be selected at the time of purchase or thereafter, as with the other program discussed above. Under this program, the original lodging reservation maker indicates his or her willingness to entertain offers for his or her lodging reservation(s). In some embodiments, the original lodging reservation maker is provided with an option to set a minimum offer price (e.g., the original lodging reservation price, a price some percentage above the original lodging reservation price, or some arbitrary price of the original lodging reservation maker's choosing). In other embodiments, the original lodging reservation maker simply elects to participate in the make-offer reseller program.

When the original lodging reservation maker elects to participate in the make-offer reseller program, a listing for each lodging reservation is created by the system. When a new buyer wishes to make a bid on the lodging reservation, he or she submits a bid through the system. The original lodging reservation maker then receives a communication from the system indicating the bid that has been received. As with the locked-in sell price reseller system, the communication to the original lodging reservation maker may account for revenue distribution to the original vendor, event organizer, venue, and/or lodging reservation redistributor and any applicable taxes in one of several fashions. In one example, the system automatically discounts the bid received from the new buyer an appropriate amount to account for the appropriate commissions/fees and taxes. Thus, if a bid is received for $450 and the commission/fee/tax will be $50, the system may communicate a bid of $400 to the original lodging reservation maker. Alternatively, the system could communicate the full bid price ($450) with an explanation of the amount to be discounted for commissions/fees/taxes along with the final amount to be received by the original lodging reservation maker upon completion of the sale.

If the original lodging reservation maker wishes to reject the offer, he or she may either take no action, or may respond to the lodging reservation redistributor or lodging reservation redistribution server that the offer is refused, and the new buyer will be notified accordingly and may opt to submit a modified bid. In some embodiments, the system may allow the original lodging reservation maker to convey a counteroffer to the new buyer that exceeds the new buyer's original bid, and if the new buyer accepts, the system could process the purchase as in the case of the locked-in sell price reseller program. The system may automatically adjust the counteroffer to account for commissions/fees/taxes, as with prior examples. If, however, the original lodging reservation maker wishes to accept the offer as-made, he or she communicates this intent to the lodging reservation redistributor or lodging reservation redistribution server, whereupon the new buyer is notified of the acceptance. Once payment is received from the new buyer (or at least sufficient payment to permit payment of the original lodging reservation maker and the commissions or fees), transfer of the lodging reservation to the new buyer, notification of the sale to the original lodging reservation maker, and notification of the sale to the original vendor, the venue, and/or the event organizer occurs in a fashion similar to that discussed above with respect to the locked-in sell price reseller program.

According to further embodiments, the original lodging reservation maker may opt in to a hybrid lodging reservation reseller program that includes aspects of both the make-offer reseller program and the locked-in sell price reseller program. Specifically, the original lodging reservation maker may select a locked-in sell price at which he or she agrees to automatically sell his or her lodging reservation, and may further indicate his or her willingness to entertain offers below the selected locked-in sell price. If the new buyer places a bid that matches (or exceeds) the locked-in sell price, the system may automatically authorize the sale and request payment from the new buyer. Once payment is received as discussed above, the lodging reservation is transferred and appropriate notifications are provided to the original lodging reservation purchaser, original reservation system, lodging provider, etc., as described previously.

Alternatively, if the new buyer places a bid that does not match or exceed the locked-in sell price, the system may accept the bid for consideration, and communicate the bid (potentially less any applicable commissions/fees/taxes) to the original lodging reservation maker. The original lodging reservation maker can reject the bid in a fashion similar to that described above. Alternatively, the original lodging reservation maker may make a counteroffer or may accept the bid, and the process may proceed as described above with respect to the make-offer reseller program.

Embodiments of the invention may provide for sale of individual lodging reservations as well as blocks of lodging reservations, so that original lodging reservation purchasers are not committed to sell fewer than all their lodging reservations if they are unwilling to do so. Accordingly, for example, the original lodging reservation purchaser may not be left holding only one of two originally purchased lodging reservations, but may require that only all or none of the originally purchased lodging reservations be resold. The system may be set up to handle a variety of flexibility requirements associated with resale/repurchase of the lodging reservations. Accordingly, every reference in the description above with respect to sale of a single lodging reservation should be understood to also refer to alternate examples involving the resale/repurchase of multiple lodging reservations at once.

As described herein, embodiments of the invention provide tight integration between original lodging reservation vendors, OTAs, event organizers, and lodging providers, on one side, a lodging reservation redistributor/lodging reservation redistribution server on a second side, and original lodging reservation makers who are willing at any time between making the lodging reservation and the first night of the reserved stay to resell their lodging reservations on a third side. The original vendor/system/lodging provider/etc. may optionally be the same entity as the lodging reservation redistributor, but even if not, the original vendor/system/lodging provider/etc. is willing to permit tight intergration with the lodging reservation redistributor/lodging reservation redistribution server because doing so allows the original vendor/system/lodging provider/etc. to participate in revenues for resales of lodging reservations at values above the original face value or purchase price. The new buyers also benefit in that they are ensured that all lodging reservations purchased through the system are valid lodging reservations. An additional effect of the system is that no reservation window need be effectively sold out. Instead, as demand increases, more expensive lodging reservation options become available through resales from original lodging reservation makers Thus, all parties benefit from the addition of lodging reservation reseller programs provided by the lodging reservation redistributor/lodging reservation redistribution server. Accordingly, the systems and methods discussed herein address deficiencies inherent in the current process for placing and cancelling lodging reservations.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method performed by a lodging reservation redistribution server including at least one processor, the method comprising:
receiving, from a lodger computing device operated by an original lodger and over a communications network, a request to place a reservation at a lodging facility;
communicating over the communications network with a lodging provider computer to place the reservation at the lodging facility;
sending a lodging reservation confirmation communication to the lodger computing device over the communications network with information about the reservation and an offer to participate in a reservation reseller program selected from the group of:
a locked-in sell price reseller program; and
a make-offer reseller program;
receiving an acceptance communication from the lodger computing device over the network, the acceptance communication indicating acceptance of the offer to participate in the reservation reseller program;
creating, by the processor, a listing available for distribution over the network to a plurality of computing devices, the listing offering the reservation for resale according to terms of the reservation reseller program accepted by the original lodger;
storing the created listing on a storage medium accessible to the lodging reservation redistribution server;
receiving a request to access one or more listings for reservations from a new lodger computing device; and
causing the processor to access the listing from the storage medium and to cause the lodging reservation redistribution server to transmit the listing over the network to the new lodger computing device.

2. The method as recited in claim 1, further comprising:
reselling the reservation from the original lodger to a new lodger at a new price greater than an original price at which the original reservation was placed;
distributing a first portion of a difference between the new price and the original price to a lodging provider operating a lodging facility booked by the reservation; and
distributing a second portion of the difference between the new price and the original price to the original lodger.

3. The method as recited in claim 2, further comprising distributing a third portion of the difference between the new price and the original price to a lodging reservation redistributor operating the lodging redistribution server.

4. The method as recited in claim 2, wherein funds for resale of the reservation are distributed at a time of resale of the reservation.

5. The method as recited in claim 2, wherein funds for resale of the reservation are distributed at a time when the new lodger pays to stay at the lodging facility pursuant to the reservation.

6. The method as recited in claim 2, further comprising receiving identifying and payment information about the new lodger and communicating the identifying and payment information to the lodging provider to replace similar information about the original lodger.

7. The method as recited in claim 2, wherein reselling the reservation comprises:
receiving, pursuant to the make-offer reseller program, an offer for the reservation from the new lodger, the offer exceeding the original price of the reservation;
preparing and transmitting an offer-made communication of the offer to the original lodger;
receiving an offer-accepted communication from the original lodger;
notifying the new lodger that the offer has been accepted;
receiving payment information and other identifying information from the new lodger; and
notifying a lodging provider computing system that the reservation has been resold to the new lodger and providing the payment information and other identifying information of the new lodger to the lodging provider computing system.

8. The method as recited in claim 2, wherein reselling the reservation comprises:
receiving, pursuant to the locked-in sell price reseller program, an offer for the reservation from the new buyer, the offer matching a sell price set by the original lodger and listed in the listing, the sell price exceeding the original price;
receiving payment information and other identifying information from the new lodger;
preparing and transmitting a reservation-sold communication to the original lodger; and
notifying a lodging provider computing system that the reservation has been resold to the new lodger and providing the payment information and the other identifying information of the new lodger to the lodging provider computing system.

9. The method as recited in claim 8, wherein the locked-in seller program comprises a time-based escalating sell price for the reservation as a start date of the reservation nears, whereby the sell price for the reservation increases with temporal proximity to the start date of the reservation.

10. The method as recited in claim 8, further comprising receiving a communication from the original lodger at the time of acceptance of the locked-in sell price reseller program, the communication providing an indication of the sell price at which the original lodger is willing to sell the reservation.

11. The method as recited in claim 1, wherein the listing comprises an end date whereupon an offer to repurchase the reservation from the original lodger will no longer be entertained.

12. The method as recited in claim 1, further comprising:
receiving, from the new lodger computing device, a search for lodging accommodations with search parameters that correspond to the created listing; and
delivering the listing over the network to the new lodger computing device as an option matching the search for lodging accommodations.

13. A method performed by a lodging reservation redistribution server including at least one processor, the method comprising:
receiving, from a lodging provider computing device and over a communications network, a notification indicating that an original lodger has placed a reservation at a lodging facility;
sending, over the communications network, an offer to a lodger computing device inviting the original lodger to participate in a reservation reseller program selected from the group of:
a locked-in sell price reseller program; and
a make-offer reseller program;
receiving an acceptance communication from the lodger computing device over the network, the acceptance communication indicating acceptance of the offer to participate in the reservation reseller program;
creating, by the processor, a listing available for distribution over the network to a plurality of computing devices, the listing offering the reservation for resale according to terms of the reservation reseller program accepted by the original lodger;
storing the created listing on a storage medium accessible to the lodging reservation redistribution server;
receiving a request to access one or more listings for reservations from a new lodger computing device; and
causing the processor to access the listing from the storage medium and to cause the lodging reservation redistribution server to transmit the listing over the network to the new lodger computing device.

14. The method as recited in claim 13, further comprising:
reselling the reservation from the original lodger to a new lodger at a new price greater than an original price at which the original reservation was placed;
distributing a first portion of a difference between the new price and the original price to a lodging provider operating a lodging facility booked by the reservation;
distributing a second portion of the difference between the new price and the original price to the original lodger; and
distributing a third portion of the difference between the new price and the original price to a lodging reservation redistributor operating the lodging redistribution server.

15. The method as recited in claim 14, further comprising receiving identifying and payment information about the new lodger and communicating the identifying and payment information to the lodging provider to replace similar information about the original lodger.

16. The method as recited in claim 14, wherein reselling the reservation comprises:
receiving, pursuant to the make-offer reseller program, an offer for the reservation from the new lodger, the offer exceeding the original price of the reservation;
preparing and transmitting an offer-made communication of the offer to the original lodger;
receiving an offer-accepted communication from the original lodger;
notifying the new lodger that the offer has been accepted;
receiving payment information and other identifying information from the new lodger; and
notifying a lodging provider computing system that the reservation has been resold to the new lodger and providing the payment information and other identifying information of the new lodger to the lodging provider computing system.

17. The method as recited in claim 14, wherein reselling the reservation comprises:
receiving, pursuant to the locked-in sell price reseller program, an offer for the reservation from the new buyer, the offer matching a sell price set by the original lodger and listed in the listing, the sell price exceeding the original price;
receiving payment information and other identifying information from the new lodger;
preparing and transmitting a reservation-sold communication to the original lodger; and
notifying a lodging provider computing system that the reservation has been resold to the new lodger and providing the payment information and the other identifying information of the new lodger to the lodging provider computing system.

18. The method as recited in claim 17, further comprising receiving a communication from the original lodger at the time of acceptance of the locked-in sell price reseller program, the communication providing an indication of the sell price at which the original lodger is willing to sell the reservation.

19. The method as recited in claim 13, further comprising:
receiving, from the new lodger computing device, a search for lodging accommodations with search parameters that correspond to the created listing; and
delivering the listing over the network to the new lodger computing device as an option matching the search for lodging accommodations.

20. A method performed by a lodging reservation redistribution server including at least one processor, the method comprising:
receiving, from a lodger computing device operated by an original lodger and over a communications network, a request to place a reservation at a lodging facility;
generating and sending a lodging reservation confirmation communication to the lodger computing device over the communications network with information about the reservation and an offer to participate in a reservation reseller program selected from the group of:
a locked-in sell price reseller program; and
a make-offer reseller program;
receiving an acceptance communication from the lodger computing device over the network, the acceptance communication indicating acceptance of the offer to participate in the reservation reseller program;
creating, by the processor, a listing available for distribution over the network to a plurality of computing devices, the listing offering the reservation for resale according to terms of the reservation reseller program accepted by the original lodger;
storing the created listing on a storage medium accessible to the lodging reservation redistribution server;
receiving a request to access one or more listings for reservations from a new lodger computing device; and
causing the processor to access the listing from the storage medium and to cause the lodging reservation redistribution server to transmit the listing over the network to the new lodger computing device.
